(19) United States
(12) Patent Application Publication
(10) Pub. No.: US 2025/0003773 A1
(43) Pub. Date: Jan. 2, 2025

(54) CAPACITOR SENSOR, ELECTRONIC DEVICE, AND PROCESSING METHOD

(71) Applicant: Lenovo (Beijing) Limited, Beijing (CN)

(72) Inventor: Qian ZHAO, Beijing (CN)

(21) Appl. No.: 18/759,195

(22) Filed: Jun. 28, 2024

(30) Foreign Application Priority Data
Jun. 30, 2023 (CN) 202310798975.2

(51) Int. Cl. G01D 5/24; G01B 7/02

(52) U.S. Cl. CPC G01D 5/24; G01B 7/023

(57) ABSTRACT

A capacitor sensor includes a first sensing channel and a second sensing channel. The first sensing channel operates in a first operation mode to obtain a first target sensing value. The first target sensing value is used to indicate a distance between a target object and a target metal segment. The second sensing channel operates in a second operation mode to obtain a second target sensing value. The second target sensing value is used to indicate a contact area between the target object and the target metal segment.

### CROSS-REFERENCE TO RELATED APPLICATION

The present disclosure claims priority to Chinese Patent Application No. 202310798975.2, filed on Jun. 30, 2023, the entire content of which is incorporated herein by reference.

### TECHNICAL FIELD

The present disclosure is related to a capacitor sensor, an electronic device, and a processing method.

### BACKGROUND

The existing capacitor sensor is only configured to detect a distance between a detection target object and a target metal segment and is not able to detect the distance between the detection target object and the target metal segment and detect a contact area between the detection target object and the target metal segment. Thus, the existing capacitor sensor has a limited application range.

### SUMMARY

An aspect of the present disclosure provides a capacitor sensor, including a first sensing channel and a second sensing channel. The first sensing channel operates in a first operation mode to obtain a first target sensing value. The first target sensing value is used to indicate a distance between a target object and a target metal segment. The second sensing channel operates in a second operation mode to obtain a second target sensing value. The second target sensing value is used to indicate a contact area between the target object and the target metal segment.

An aspect of the present disclosure provides an electronic device, including a target metal segment and a capacitor sensor. The capacitor sensor is connected to the target metal segment and includes a first sensing channel and a second sensing channel. The first sensing channel operates in a first operation mode to obtain a first target sensing value. The first target sensing value is used to indicate a distance between a target object and a target metal segment. The second sensing channel operates in a second operation mode to obtain a second target sensing value. The second target sensing value is used to indicate a contact area between the target object and the target metal segment.

An aspect of the present disclosure provides a processing method. The method includes obtaining a first target sensing value, in response to the first target sensing value satisfying a target threshold, obtaining a trigger instruction, and obtaining a second target sensing value based on the trigger instruction. The first target sensing value is a sensing value obtained by a first sensing channel of a capacitor sensor operating in a first operation mode. The first target sensing value is used to indicate a distance between a target object and a target metal segment. The trigger instruction is used to indicate that the target object is in contact with the target metal segment. The second target sensing value is a sensing value obtained by a second sensing channel of the capacitor sensor operating in a second operation mode. The second target sensing value is used to indicate a contact area between the target object and the target metal segment.

### BRIEF DESCRIPTION OF THE DRAWINGS

FIG. 1 illustrates a schematic structural diagram of a capacitor sensor according to some embodiments of the present disclosure.

FIG. 2 illustrates a schematic structural diagram of an electronic device according to some embodiments of the present disclosure.

FIG. 3 illustrates a schematic structural diagram of another capacitor sensor according to some embodiments of the present disclosure.

FIG. 4 illustrates a schematic diagram of a processing method according to some embodiments of the present disclosure.

### DETAILED DESCRIPTION OF THE EMBODIMENTS

To make the objectives, technical solutions, and advantages of the present disclosure clearer, the technical solutions of the present disclosure are described in detail in conjunction with the accompanying drawings. Described embodiments are only some embodiments of the present disclosure, not all embodiments. All other embodiments obtained by those skilled in the art without creative efforts are within the scope of the present disclosure. Embodiments and features of embodiments of the present disclosure can be combined arbitrarily with each other when there is no conflict. The steps shown in the flowchart can be executed in a computer system such as a set of computer-executable instructions. Although a logical sequence is shown in the flowchart, in some cases, the steps can be executed or described in an order different from the order shown in the flowchart.

The technical solutions of the present disclosure are further described in detail in conjunction with the accompanying drawings and specific embodiments of the present disclosure.

FIG. 1 illustrates a schematic structural diagram of a capacitor sensor according to some embodiments of the present disclosure. As shown in FIG. 1, the capacitor sensor includes a first sensing channel 11 and a second sensing channel 12. The first sensing channel 11 can operate based on a first operation mode to obtain a first target sensing value. The first target sensing value can be used to represent a distance between a target object and a target metal segment. A second sensing channel 12 can operate based on a second operation mode to obtain a second target sensing value. The second sensing value can be used to represent a contact area between the target object and the target metal segment.

The target object can include, but is not limited to, a living human and a part of a human, such as a hand, a finger, an ear, a face, etc. The target metal segment can belong to the capacitor sensor or a detection apparatus including the capacitor sensor. For example, the detection apparatus can include a cellphone, a PAD, a watch, a wristband, a health wearable device, a gaming console, etc.

In the present disclosure, the capacitor sensor can further include a first function module 13, a second function module 14, and a third function module 15. The first function module 13 and the second function module 14 can operate in the first operation mode. The third function module 15 can operate in the second operation mode. The first function module 13 and the third function module 15 can be the same, while the first function module 13 and the second function module 14 can be different.

For example, the first function module 13 and the third function module 15 can be configured to perform capacitor calibration on corresponding sensing channels, respectively. The second function module 14 can be configured to perform reciprocal measurement on the distance between the target object and the target metal segment.

In the present disclosure, the second sensing channel 12 can be configured to respond to a trigger instruction. The trigger instruction can be used to indicate that the target object is in contact with the target metal segment. The second sensing channel 12 can operate in the second operation mode based on the trigger instruction. That is, when the first sensing channel 11 obtains a first target sensing value indicating that the target object is not in contact with the target metal segment based on the first operation mode, the second sensing channel can be in a non-operation state.

In the present disclosure, the first function module 13 can be configured to obtain a first capacitance value. The first capacitance value can include the capacitance of the target metal segment connected to the capacitor sensor and a plate capacitance of the capacitor sensor. The third function module 15 can be configured to obtain a second capacitance value. The second capacitance value can include the capacitance of the target metal segment connected to the capacitor sensor, the plate capacitance of the capacitor sensor, and a capacitance of the target object in contact with the target metal segment. The plate capacitance can include at least one of a parasitic capacitance formed between a substrate and ground or a parasitic capacitance formed by a first substrate and a second substrate.

The first capacitance value can be a compensation capacitance determined by the first function module 13 by adjusting a capacitor array to cause an output result of the first function module 13 to be 0. The second capacitance value can be a compensation capacitance determined by the third function module 15 by adjusting a capacitor array to cause an output result of the third function module 15 to be 0.

The capacitance (Cx) of the capacitor sensor can include a parasitic capacitance (Cp) and a variable capacitance (ΔC). The parasitic capacitance (Cp) can be a fixed capacitance value, while the variable capacitance (ΔC) can change when a finger approaches the sensor. In practical applications, the value of the parasitic capacitance can be much larger than the value of the variable capacitance (ΔC). The variable capacitance (ΔC) can be effective for the capacitor sensor. If the parasitic capacitance (Cp) is too large, the capacitance detection circuit can be saturated and cannot detect the change in the variable capacitance (ΔC). Thus, compensation can be performed on the parasitic capacitance (Cp) fixed in the capacitor sensor. A compensated parasitic capacitance (Cp′) is Cp′=Cp−Cb. Cb can denote a compensation capacitance value. In the present disclosure, regardless of whether the capacitor sensor is detected using a self-capacitance structure or a mutual-capacitance structure, the purpose of compensating the parasitic capacitance can include finding a suitable compensation capacitance value (Cb) to cause Cp′ to equal to or be 0 as close as possible. Thus, when the variable capacitance ΔC=0, the output signal of the sensor apparatus can be around zero. Then, when an object approaches, the change in the variable capacitance (ΔC) can be effectively reflected in the change in the output signal.

In the present disclosure, the second function module 14 can be configured to obtain a third capacitance value. The third capacitance value can include a capacitance of the target metal segment connected to the capacitor sensor, a plate capacitance of the capacitor sensor, and a capacitance of the target object in contact with the target metal segment. The third capacitance value can be the variable capacitance (ΔC) detected by the first function module 13 by adjusting the capacitor array to cause the output result of the first function module 13 to be 0. If the variable capacitance (ΔC) changes, and the change value of the variable capacitance (ΔC) is within a predetermined range of an analog-to-digital converter (ADC) and is a positive value, the target object can be determined to be in contact with the target metal segment. Otherwise, the target object and the target metal segment can be determined to be in a non-contact state.

For example, the predetermined range of the ADC can be +/−5 pf, and the change value in the current variable capacitance (ΔC) can be 5 pf or 4.5 pf. Then, the target object can be determined to be in contact with the target metal segment. If the change value in the current variable capacitance (ΔC) is −5 pf or −4.5 pf, the target object and the target metal segment can be determined to be in the non-contact state.

In the present disclosure, the second target sensing value can be determined by processing the second capacitance value and the first capacitance value.

For example, the capacitance difference between the second capacitance value and the first capacitance value can be used as the second target sensing value.

In the capacitor sensor of embodiments of the present disclosure, with the two sensing channels, the first sensing channel can be configured to detect the distance between the target object and the target metal segment, and the second sensing channel can be configured to detect the contact area between the target object and the target metal segment. Thus, detection with high sensitivity can be performed, and the current grip posture of the target object can be recognized based on the contact area.

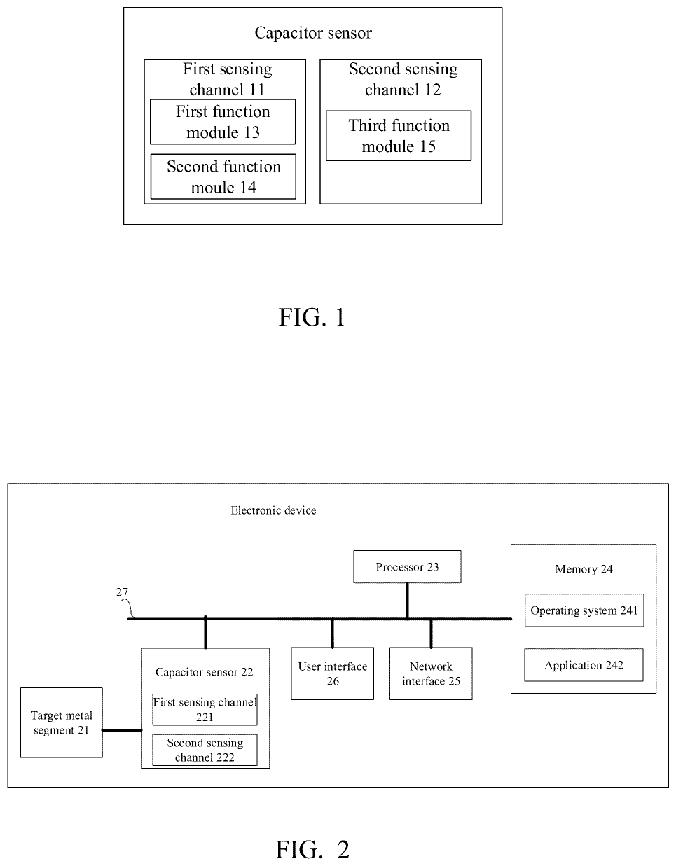

FIG. 2 illustrates a schematic structural diagram of an electronic device according to some embodiments of the present disclosure. The electronic device can include but is not limited to a cellphone, a watch, a wristband, a PAD, a gaming console, and a wearable device. As shown in FIG. 2, the electronic device includes a target metal segment 21 and a capacitor sensor 22. The capacitor sensor 22 can include a plurality of pins. Each pin can be connected to a target metal segment 21. Each pin of the capacitor sensor 22 can include the first sensing channel 221 and the second sensing channel 222. The first sensing channel 221 can operate in the first operation mode to obtain the first target sensing value. The first target sensing value can be used to indicate the distance between the target object and the target metal segment 21. The second sensing channel 222 can operate in the second operation mode to obtain the second target sensing value. The second target sensing value can be used to indicate the contact area between the target object and the target metal segment 21.

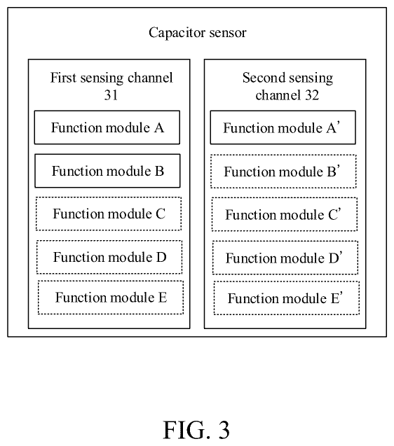

A same pin of the capacitor sensor 22 can include two logical channels, including the first sensing channel 221 and the second sensing channel 222. The first sensing channel 221 and the second sensing channel 222 each can include a plurality of function modules. Functions of the function modules of each sensing channel can be the same or different. By configuring the function modules differently in different sensing channels, the two sensing channels can achieve the target functions (details are shown in FIG. 3).

The target metal segment 21 can be a part of or be an antenna of the electronic device or can be independent of the antenna. When the target metal segment 21 is independent of the antenna of the electronic device, a distance between the target metal segment 21 and the antenna may need to satisfy a signal interference resistance condition.

In embodiments of the present disclosure, the electronic device can also include a processor 23. The processor 23 can be configured to, in response to the first target sensing value satisfying the target threshold, obtain a trigger instruction. The trigger instruction can be used to instruct the second sensing channel 222 of the capacitor sensor 22 to operate in the second operation mode.

When the first target sensing value obtained through the first sensing channel 221 indicates that the target object is in contact with the target metal segment 21, the first target sensing value can be determined to satisfy the target threshold. Then, the processor 23 can obtain the trigger instruction to cause the second sensing channel 222 to operate in the second operation mode to obtain the second target sensing value. The contact area between the target object and the target metal segment can be determined through the second target sensing value.

The first target sensing value can be compared with the target threshold. When the difference between the first target sensing value and the target threshold is greater than or equal to the predetermined value, the first target sensing value can be determined to satisfy the target threshold. When the difference between the first target sensing value and the target threshold is less than the predetermined value, the current state of the second sensing channel 222 can be kept unchanged, and the first sensing channel 211 can be caused to continue to operate in the first operation mode to obtain the first target sensing value until the first target sensing value is detected to satisfy the target threshold. Then, the trigger instruction can be obtained to trigger the second sensing channel 222 of the capacitor sensor 22 to operate in the second operation mode.

In the present disclosure, the capacitor sensor 22 can be the same as the capacitor sensor in FIG. 1. For the detailed structure and implementation, reference can be made to the relevant description of the capacitor sensor in FIG. 1.

The processor 23 can be an integrated circuit chip having a signal processing capability. During implementation, the signal processing can be accomplished through integrated logic circuits in the hardware of the processor 23 or software-based instructions. The processor 23 can be a general-purpose processor, digital signal processor (DSP), other programmable logic devices, discrete gate or transistor logic devices, discrete hardware assemblies, etc. The general-purpose processor can be a microprocessor or any conventional processor.

This electronic device can also include a memory 24, at least one network interface 25, and a user interface 26. Various assemblies in the electronic device can be coupled together via a bus system 27. The bus system 27 can be configured to realize the connection and communication between these assemblies. The bus system 27 can include a data bus, power bus, control bus, and state signal bus. For clarity, all buses are collectively referred to as the bus system 27 in FIG. 2.

The user interface 26 can include a display, keyboard, mouse, trackball, click wheel, buttons, keys, touchpads, or touch screens.

The memory 24 can be volatile or non-volatile. The memory 24 can also include a volatile memory and a non-volatile memory. The non-volatile memory can include a read-only memory (ROM), programmable read-only memory (PROM), erasable programmable read-only memory (EPROM), electrically erasable programmable read-only memory (EEPROM), ferroelectric random-access memory (FRAM), flash memory, magnetic surface memory, or compact disc read-only memory (CD-ROM). The magnetic surface memory can include a disk memory or tape memory. The volatile memory can include a random access memory (RAM), which can be used as an external cache memory. The RAM can include but is not limited to a static random access memory (SRAM), synchronous static random access memory (SSRAM), dynamic random access memory (DRAM), synchronous dynamic random access memory (SDRAM), double data rate synchronous dynamic random access memory (DDR SDRAM), enhanced synchronous dynamic random access memory (ESDRAM), synclink dynamic random access memory (SLDRAM), and direct Rambus random access memory (DRRAM). The memory 24 of embodiments of the present disclosure is intended to include, but is not limited to, these and any other suitable types of memory.

The memory 24 of the present disclosure can be used to store various types of data to support the operation of the electronic device. The data can include any computer programs operating on the electronic device, such as an operating system 241 and an application program 242, contact information, phonebook data, messages, images, and audios. The operating system 241 can include various system programs, such as framework layers, core libraries, and driver layers, which are used to implement various foundational services and process hardware-based tasks. The application program 242 can include various applications, such as a media player and a browser, to implement different application tasks. Programs that implement the method of the present disclosure can be included in the application program 242.

In the electronic device of the present disclosure, by connecting a target metal body to two sensing channels of a capacitor sensor. One sensing channel can be configured to detect the distance between the target object and the target metal body in the first operation mode. The other sensing channel can be configured to detect the contact area between the target object and the target metal body in the second operation mode. The first operation mode can represent the capacitance detection mode, and the second operation mode can represent a capacitor calibration mode. The first operation mode can also include a calibration function. However, the capacitor calibration in the first operation mode can be intended to detect the contact state between the target object and the target metal body, and the capacitor calibration in the second operation mode can be intended to detect the contact area between the target object and the target metal body. The capacitor calibrations can have different effects. Thus, the detection with the high sensitivity of the capacitor sensor can be ensured, and the current grip posture can be recognized.

The electronic device and the capacitor sensor can be implemented in the same concept. For detailed implementation, reference can be made to the capacitor sensor, which is not repeated here.

FIG. 3 illustrates a schematic structural diagram of another capacitor sensor according to some embodiments of the present disclosure.

As shown in FIG. 3, the same pin of the capacitor sensor can logically include the first sensing channel 31 and the second sensing channel 32. The first sensing channel 31 and the second sensing channel 32 each can include a plurality of same function modules. The plurality of function modules can be configured differently. As shown in FIG. 3, each of the first sensing channel 31 and the second sensing channel 32 includes five function modules, such as A, B, C, D, and E. Function module A and function module B of the first sensing channel 31 can be configured to be in an effective state, and function module C, function module D, and function module E can be configured to be in a non-effective state. Function module A′ of the second sensing channel 32 can be configured to be in an effective state, and the other function modules of the second sensing channel 32 can be configured to be in the non-effective state. For example, function module A and function module A′ can have modules with the calibration function. Function module B can have a module with a detection function. When a shared pin of the first sensing channel 31 and the second sensing channel 32 is connected to the target metal segment, a path can be formed. When no target object is in contact with the target metal segment, function module A can detect the first capacitance value (including the capacitance of the pin and the capacitance of the target metal segment) of the first path. Function module A can cause the output result of function module A in the first path to be 0 by adjusting the capacitor array of the function module corresponding to the first capacitance value. Thus, if a target object approaches the target metal segment, the value corresponding to the capacitor array adjusted by function module A can change. Function module B can detect the capacitance value of +/−5 pf generated in the first path. The distance between the target object and the target metal segment can be determined according to the capacitance value of +/−5 pf. The distance can indicate whether the contact state of the target object and the target meal segment is contact or non-contact. When the target object and the target metal segment are determined to be in the contact state based on the distance between the target object and the target metal segment, function module A′ of the second sensing channel 32 can be triggered. Thus, when the target object is in contact with the target metal segment, function module A′ can detect the second capacitance value (including a capacitance of the pin, a capacitance of a target metal segment, and a capacitance of a target object) of the first path. Then, the capacitance value indicating the contact area between the target object and the target metal segment can be obtained through the difference between the second capacitance value and the first capacitance value.

When detecting the first capacitance value of the first path, the first sensing channel cannot determine the distance between the target object and the target metal segment, i.e., the contact state. Thus, when the target object and the target metal segment are determined by the first sensing channel to be in the contact state, the second sensing channel can be enabled to detect the contact area between the target object and the target metal segment. Thus, the distance between the target object and the target metal segment can be detected, and the contact area between the target object and the target metal segment can be also detected.

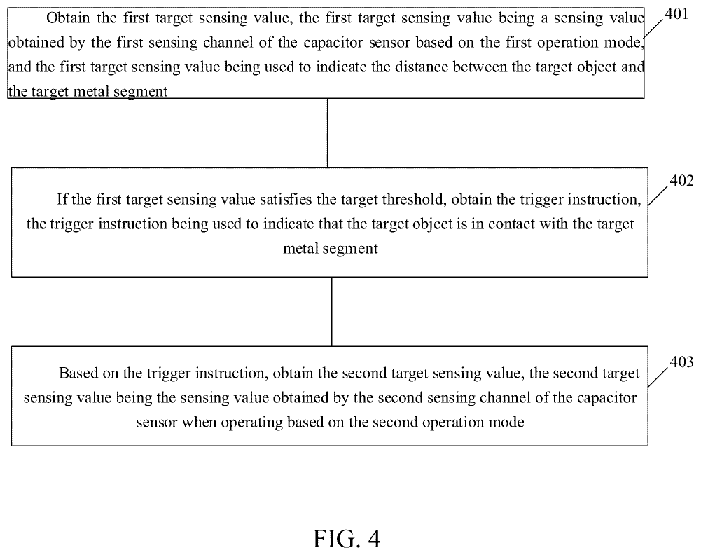

FIG. 4 illustrates a schematic diagram of a processing method according to some embodiments of the present disclosure. The method can be applied to the above electronic device. As shown in FIG. 4, the method includes the following steps.

At 401, the first target sensing value is obtained. The first target sensing value is a sensing value obtained by the first sensing channel of the capacitor sensor based on the first operation mode. The first target sensing value is used to indicate the distance between the target object and the target metal segment.

A plurality of first target sensing values can be obtained. Different first target sensing values can indicate distances between different target objects and the corresponding target metal segments. For example, the different target objects can be different users, different parts of the same user, or different positions of a same part of the same user.

The first operation mode can include the first function module and the second function module. The first function module and the second function module can belong to the capacitor sensor, and the first function module can be different from the second function module. For example, the first function module can be configured to calibrate the capacitance value of the first sensing channel, and the second function module can be configured to perform repeated capacitance detection through the first sensing channel to determine the distance between the target object and the target metal segment according to the detected capacitance value.

The first function module can be configured to obtain the first capacitance value. The first capacitance value can include the capacitance of the target metal segment connected to the capacitor sensor and the plate capacitance of the capacitor sensor. The first capacitance value can be the compensation capacitance value determined by the first function module by adjusting the capacitor array to cause the output result of the first function module to be 0. The second function module can be configured to obtain the third capacitance value when adjusting the output result of the first function module to be 0. The third capacitance value can include the capacitance of the target metal segment connected to the capacitor sensor, the plate capacitance of the capacitor sensor, and the capacitance of the target object in contact with the target metal segment. Moreover, the third capacitance value can indicate the distance between the target object and the target metal segment to determine the contact state of the target object and the target metal segment.

At 402, if the first target sensing value satisfies the target threshold, the trigger instruction is obtained. The trigger instruction is used to indicate that the target object is in contact with the target metal segment.

The first target sensing value can be compared to the adjusted output capacitance value of the first sensing channel of the capacitor sensor. If the comparison result indicates that the difference between the first target sensing value and the output capacitance value is in the ADC range and positive data (e.g., the ADC range being +/−5 pf, and the first target sensing value being 4.5 pf), the first target sensing value can satisfy the target threshold. The target object can be in contact with the target metal segment. Then, the trigger instruction indicating that the target object is in contact with the target metal segment can be obtained. The trigger instruction can be used to trigger the second sensing channel of the capacitor sensor. On the contrary, if the comparison result indicates that the difference between the first target sensing value and the output capacitance value falls in the ADC range but is negative data (e.g., −5 pf), the first target sensing value can be determined to not satisfy the target threshold. Thus, the target object may not be in contact with the target metal segment. Thus, the second sensing channel may not be triggered, and the first sensing channel can continue to be enabled to operate in the first operation mode.

At 403, based on the trigger instruction, the second target sensing value is obtained. The second target sensing value is the sensing value obtained by the second sensing channel of the capacitor sensor when operating based on the second operation mode.

A plurality of second target sensing values can be obtained. Different second target sensing values can indicate contact areas between different target objects and the corresponding target metal segments, respectively. For example, the different target objects can be different users, different parts of a same user, or different positions of a same part of the same user. For example, the ear of the user can correspond to the first target metal segment of the cellphone, the finger of the user can correspond to the second target metal segment of the cellphone, and the face of the user can correspond to the third target metal segment of the cellphone.

The second operation mode can include a third function module. The third function module that can belong to the capacitor sensor can be the same as the first function module. For example, the first function module and the third function module can be configured to calibrate the capacitance.

The third function module can be configured to obtain the second capacitance value. The second capacitance value can include the capacitance of the target metal segment connected to the capacitor sensor, the plate capacitance of the capacitor sensor, and the capacitance of the target object in contact with the target metal segment. Moreover, the second capacitance value can be the compensation capacitance value determined by the third function module by adjusting the capacitor array to cause the output result of the third function module to be 0, which can be determined through the capacitance difference between the second capacitance value and the first capacitance value.

In some embodiments, the grip posture can be determined based on the plurality of second target sensing values.

In some embodiments, the plurality of second target sensing values can be compared. The positions of the target metal segments corresponding to the plurality of the second target sensing values can be different. If the comparison result indicates that the difference between the plurality of the second target sensing values of the first area is less than the threshold, and the plurality of second target sensing values of the first area are greater than the plurality of second sensing values of the second area, the single hand grip posture can be determined currently. The positions of the target metal segments corresponding to the plurality of second target sensing values of the first area can be neighboring to each other. The positions of the target metal segments corresponding to the plurality of second target sensing values of the second area can be neighboring to each other.

Whether the grip posture is currently a left-hand grip posture or a right-hand grip posture can be determined based on the identifiers corresponding to the current first area and the second area. For example, when the first area corresponds to a left-hand identifier, and the second area corresponds to a right-hand identifier, the current grip posture can be determined to be the left-hand grip posture.

In the processing method of the present disclosure, by connecting the target metal body to two sensing channels of the capacitor sensor. One sensing channel can be configured to detect the distance between the target object and the target metal body based on the first operation mode, and the other sensing change can be configured to detect the contact area between the target object and the target metal segment based on the second operation mode. The first operation mode can be used to represent the capacitance detection mode, and the second operation mode can be used to represent the capacitance calibration mode. The first operation mode can also have the calibration function. However, the capacitance calibration in the first operation mode can be intended to detect the contact state of the target object and the target metal body, and the capacitance calibration in the second operation mode can be intended to detect the contact area between the target object and the target metal body, which have different implementation effects. Thus, the detection with the high sensitivity of the capacitor sensor can be ensured, and the current grip posture can be identified.

The processing method, the electronic device, and the capacitor sensor of embodiments of the present disclosure belong to the same concept. For the implementation, reference can be made to the implementation of the capacitor sensor, which is not repeated here.

Embodiments of the present disclosure further provide an electronic device. The electronic device can include a processor and a memory used to store a computer program that is able to run on the processor that, when executed by the processor, causes the processor to perform the steps of the processing method.

In embodiments of the present disclosure, the device and methods can be implemented in other methods. The device embodiments above are merely illustrative. For example, the unit division can be merely a logical functional division. The unit can be divided with other methods in actual implementation. For example, a plurality of units or assemblies can be combined or integrated into another system, or some features can be omitted or may not be executed. In addition, couplings, direct couplings, or communicative connections between components displayed or discussed can be indirect couplings or communicative connections through some interfaces, devices, or units and can be electrical, mechanical, etc.

The unit described as a separate member can be or may not be physically separated. A member displayed as a unit can be or may not be a physical unit. That is, the member can be located in one place or distributed at the plurality of network units. Some or all of the units can be selected according to the actual needs to implement the technical solutions of embodiments of the present disclosure.

The methods disclosed in method embodiments of the present disclosure can be arbitrarily grouped when there is no conflict to obtain new method embodiments.

The features disclosed in product embodiments of the present disclosure can be arbitrarily grouped when there is no conflict to obtain new product embodiments.

The features disclosed in method embodiments and device embodiments of the present disclosure can be arbitrarily grouped when there is no conflict to obtain new method embodiments or device embodiments.

The above are embodiments of the present disclosure. However, the scope of the present disclosure is not limited to this. Those skilled in the art can easily think of modifications or replacements within the scope of the present disclosure. These modifications and replacements can be within the scope of the present disclosure. Thus, the scope of the present disclosure is subject to the appended claims.

What is claimed is:

1. A capacitor sensor comprising:
a first sensing channel operating in a first operation mode to obtain a first target sensing value, the first target sensing value being used to indicate a distance between a target object and a target metal segment; and
a second sensing channel operating in a second operation mode to obtain a second target sensing value, the second target sensing value being used to indicate a contact area between the target object and the target metal segment.

2. The capacitor sensor according to claim 1, wherein:
the first operation mode includes a first function module and a second function module;
the second operation mode includes a third function module;
the first function module, the second function module, and the third function module belong to the capacitor sensor;
the first function module is the same as the third function module; and
the first function module is different from the second function module.

3. The capacitor sensor according to claim 2, wherein in response to a trigger instruction, the second sensing channel operates in the second operation mode, the trigger instruction being used to indicate that the target object is in contact with the target metal segment.

4. The capacitor sensor according to claim 3, wherein:
the first function module is configured to obtain a first capacitance value, the first capacitance value including a capacitance of the target metal segment connected to the capacitor sensor and a plate capacitance of the capacitor sensor; and
the third function module is configured to obtain a second capacitance value, the second capacitance value including the capacitance of the target metal segment connected to the capacitor sensor, the plate capacitance of the capacitor sensor, and a capacitance of the target object in contact with the target metal segment; and
the plate capacitance includes one of a parasitic capacitance formed between a substrate and ground and a parasitic capacitance formed between a first substrate and a second substrate.

5. The capacitor sensor according to claim 4, wherein:
the first capacitance value is a compensation capacitance value determined by the first function module by adjusting a capacitor array to cause an output result of the first function module to be zero; and
the second capacitance value is a compensation capacitance value determined by the third function module by adjusting the capacitor array to cause an output result of the third function module to be zero.

6. The capacitor sensor according to claim 5, wherein the second target sensing value is determined by processing the second capacitance value and the first capacitance value.

7. An electronic device comprising:
a target metal segment; and
a capacitor sensor connected to the target metal segment and including:
a first sensing channel operating in a first operation mode to obtain a first target sensing value, the first target sensing value being used to indicate a distance between a target object and the target metal segment; and
a second sensing channel operating in a second operation mode to obtain a second target sensing value, the second target sensing value being used to indicate a contact area between the target object and the target metal segment.

8. The device according to claim 7, further comprising:
a processor configured to, in response to the first target sensing value satisfying a target threshold, obtain a trigger instruction, the trigger instruction being used to instruct the second sensing channel of the capacitor sensor to operate in the second operation mode.

9. The device according to claim 7, wherein:
the first operation mode includes a first function module and a second function module;
the second operation mode includes a third function module;
the first function module, the second function module, and the third function module belong to the capacitor sensor;
the first function module is the same as the third function module; and
the first function module is different from the second function module.

10. The device according to claim 9, wherein:
the first function module is configured to obtain a first capacitance value, the first capacitance value including a capacitance of the target metal segment connected to the capacitor sensor and a plate capacitance of the capacitor sensor;
the third function module is configured to obtain a second capacitance value, the second capacitance value including the capacitance of the target metal segment connected to the capacitor sensor, the plate capacitance of the capacitor sensor, and a capacitance of the target object in contact with the target metal segment; and
the plate capacitance includes one of a parasitic capacitance formed between a substrate and ground and a parasitic capacitance formed between a first substrate and a second substrate.

11. The device according to claim 10, wherein:
the first capacitance value is a compensation capacitance value determined by the first function module by adjusting a capacitor array to cause an output result of the first function module to be zero; and
the second capacitance value is a compensation capacitance value determined by the third function module by adjusting the capacitor array to cause an output result of the third function module to be zero.

12. The device according to claim 11, wherein the second target sensing value is determined by processing the second capacitance value and the first capacitance value.

13. The device according to claim 7, wherein the target metal segment is an antenna of the electronic device.

14. A processing method comprising:
obtaining a first target sensing value, the first target sensing value being a sensing value obtained by a first sensing channel of a capacitor sensor operating in a first operation mode, and the first target sensing value being used to indicate a distance between a target object and a target metal segment;
in response to the first target sensing value satisfying a target threshold, obtaining a trigger instruction, the trigger instruction being used to indicate that the target object is in contact with the target metal segment; and
obtaining a second target sensing value based on the trigger instruction, the second target sensing value being a sensing value obtained by a second sensing channel of the capacitor sensor operating in a second operation mode, and the second target sensing value being used to indicate a contact area between the target object and the target metal segment.

15. The method according to claim 14, wherein obtaining the first target sensing value includes:
obtaining a plurality of first target sensing values, different first target sensing values indicating distances between different target objects and target metal segments corresponding to the different target objects.

16. The method according to claim 14, wherein obtaining the second target sensing value includes:
obtaining a plurality of second target sensing values, different second target sensing values indicating contact areas between the different target objects and the target metal segments corresponding to the different target objects.

17. The method according to claim 16, further comprising determining a grip posture based on the plurality of second target sensing values.
